(19) United States
(12) Patent Application Publication
(10) Pub. No.: US 2023/0342633 A1
(43) Pub. Date: Oct. 26, 2023

(54) SIMULATION-AUGMENTED DECISION TREE ANALYSIS AND IMPROVEMENT METHOD, COMPUTER PROGRAM PRODUCT, AND SYSTEM

(71) Applicant: SIEMENS AKTIENGESELLSCHAFT, 80333 München (DE)

(72) Inventors: Daniel Berger, Nürnberg (DE); Christoph Paulitsch, Karlsruhe (DE)

(21) Appl. No.: 18/021,045

(22) PCT Filed: Aug. 13, 2020
(86) PCT No.: PCT/EP2020/072740

§ 371 Date: Feb. 13, 2023

(51) Int. Cl. G06N 5/022; G05B 19/4155

(52) U.S. Cl. CPC G06N 5/022; G05B 19/4155; G05B 2219/32343

(57) ABSTRACT

A method includes inputting input data including data acquired during operation, and amending the input data with feature information. The input data is applied in a decision tree analytics model, with each leaf of the decision tree representing a machine state associated with a label giving information about feature values and operational conditions of the manufacturing system. Branches of the decision tree represent conjunctions of feature information that lead to the states and labels. At least one simulation model shows dependencies between the label and the input data, and one or more simulation models of the at least one simulations model replace at least one part of at least one of the branches of the tree.

This application is the National Stage of International Application No. PCT/EP2020/072740, filed Aug. 13, 2020. The entire contents of this document is hereby incorporated herein by reference.

### BACKGROUND

A manufacturing system is a collection or arrangement of operations and processes used to make a desired product or component. The manufacturing system includes the actual equipment for composing the processes and the arrangement of those processes. In a manufacturing system, if there is a change or disturbance in the system, the system may accommodate or adjust itself and continue to function efficiently.

Simulation in manufacturing systems provides for the use of software to make computer models of manufacturing systems, to analyze the computer models, and thereby obtain useful information about the operational behavior of the system and of the material flow in the system. A schematic representation of such a system is shown in FIG. 3, with data acquisition via sensors S1, . . . Sn over a programmable logic controller (PLC) and collectors for actuators such as an inverter signals I1, I2, collection of such data in Data Servers DS, connection via Edge devices, Edge, and/or a data cloud, 300, and analysis of the data in an analytics server AS to be computed with data simulation software SiS, and user interface HMI.

Physical simulation models of automated factories and plants contain all kinds of useful information about the operation behavior.

One State-of-the-art approach to employ simulations to improve the performance of machine learning approaches is depicted in FIG. 2. Currently, simulation data I is used to train machine learning models for the analysis 200 of automation data to determine and predict failures and optimize behavior, but not additional information from the model itself.

Simulation models are routinely used during the engineering phase (e.g., to determine the optimal design or parameterization of drive controllers). The simulation models are also used to produce training data for condition monitoring and failure prediction algorithms.

It is already known for condition monitoring and predictive maintenance to provide a combination of real sensor data and data from simulations during the training phase of the underlying machine learning (ML) model.

In machine learning, a feature is an individual measurable property or characteristic of a phenomenon being observed. Choosing informative, discriminating, and independent feature information is a step for effective algorithms in pattern recognition, classification, and regression. Feature information is often numeric, as in the chosen examples later.

The state of the art is schematically depicted in FIG. 2, where the input data, I, is labeled in a Feature Generator, FG, first, and then, this labeled data is used by the Machine Learning Algorithm MLA, to produce an output L. The label may be, for example, “normal operation” or one or more “failure conditions.” During operation, the pretrained ML model analyzes data input I from sensors and similar sources. The raw sensor data I is input to an element that extracts feature information values that are then input to the ML algorithm itself.

An example of a Machine Learning algorithm is a Gradient Boosted Decision Tree. It is already known to the expert in the field to use simulation methods to provide training data for decision tree models, also referred to as Decision Tree Analysis, DTA.

Decision tree learning is one of the predictive modelling approaches used in statistics, data mining, and machine learning. Decision tree learning uses a decision tree (e.g., as a predictive model) to go from observations about an item (e.g., represented in the branches) to conclusions about the item's target value (e.g., represented in the leaves). https://en.wikipedia.org/wiki/Decision_tree_learning. Publication CN 109241649 A describes such a method for composite material detection, where training data is provided by finite elements simulations. CN 109239585 A uses circuit simulation data to train decision models for failure detection in electrical circuits.

However, during runtime, sensor data is typically analyzed independent of the simulation models. Such a procedure wastes valuable information and therefore is compromising the performance of the condition monitoring system.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method, computer program product, and system to overcome the described disadvantages of the known method and provide the possibility to enter additional information from the model as described are provided.

A method for an augmented decision tree analysis in a Machine Learning algorithm for a manufacturing system includes inputting of input data containing data acquired during operation, amending of input data with feature information, and applying the input data in a decision tree analytics model with each leaf of the decision tree representing a machine state associated with a label giving information about feature values and operational conditions of the manufacturing system. Branches of the decision tree represent conjunctions of feature information that lead to those states and labels. There is at least one Simulation Model that shows dependencies between the label and the input data, and at least one of the Simulations models is replacing at least one part of at least one of the branches of the tree.

### BRIEF DESCRIPTION OF THE DRAWINGS

FIG. 1 is an overview of a trained model used for continuous classification on given input and output data according to an embodiment;

FIG. 2 is an approach for machine learning of the prior art;

FIG. 3 shows a system with data acquisition, data simulation software; and user interface;

FIG. 4 shows available simulation models for data;

FIG. 5 shows examples for signals;

FIG. 6 shows a test valid range for model;

FIG. 7 illustrates determining a best fit between model and feature information;

FIG. 8 illustrates determining best fit between model and feature information continued;

FIG. 9 illustrates determining best fit between model and label;

FIG. 10 illustrates in case of contradictions, using DTA to improve simulation model;

FIG. 11 shows an airport tilter example to include correct resonance frequency in model;

FIG. 12 illustrates based on simulation model, choosing best DTA;

FIG. 13 illustrates decision tree analysis DTA with simulation models;

FIG. 14 illustrates replacing DTA branch by model to sharpen classification area; and

FIG. 15 is an overview of the analytics process for condition monitoring.

### DETAILED DESCRIPTION

The proposed approach differs substantially from the described state of the art.

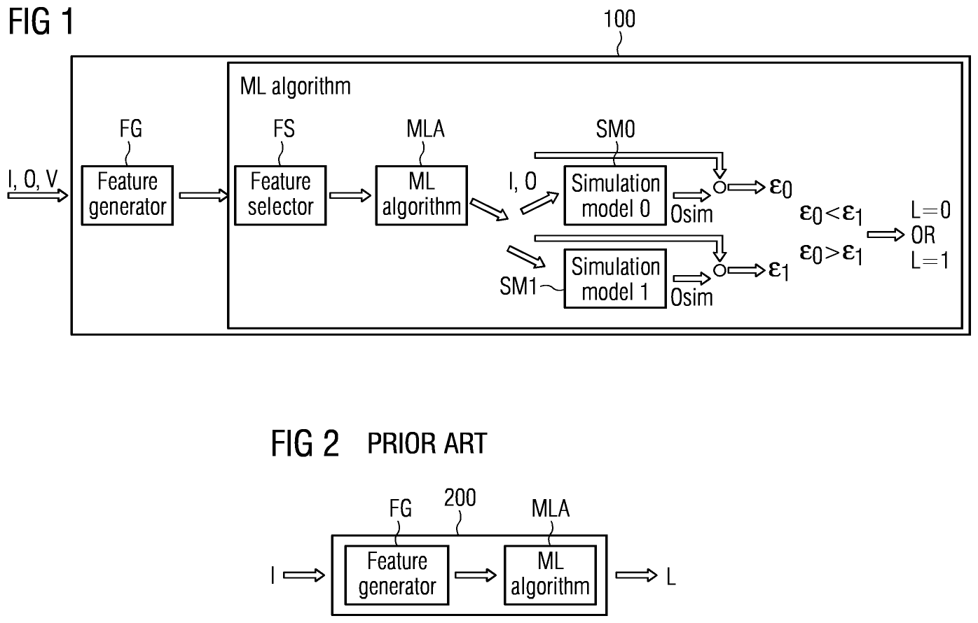

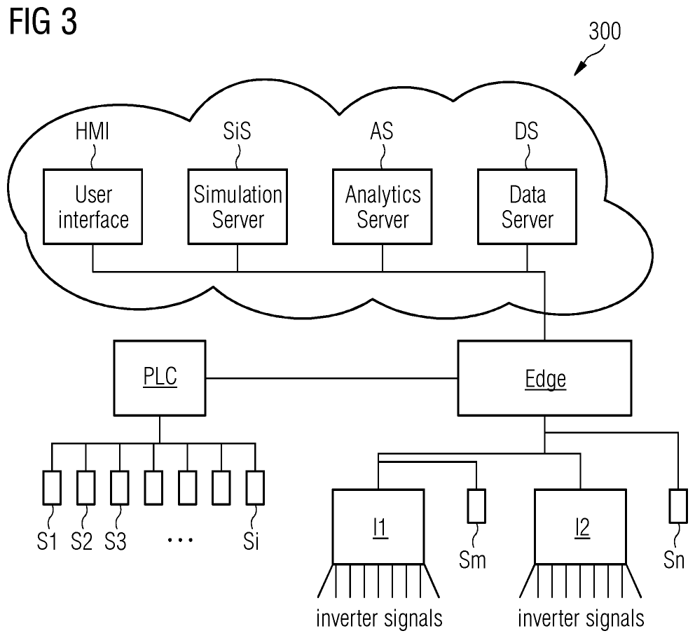

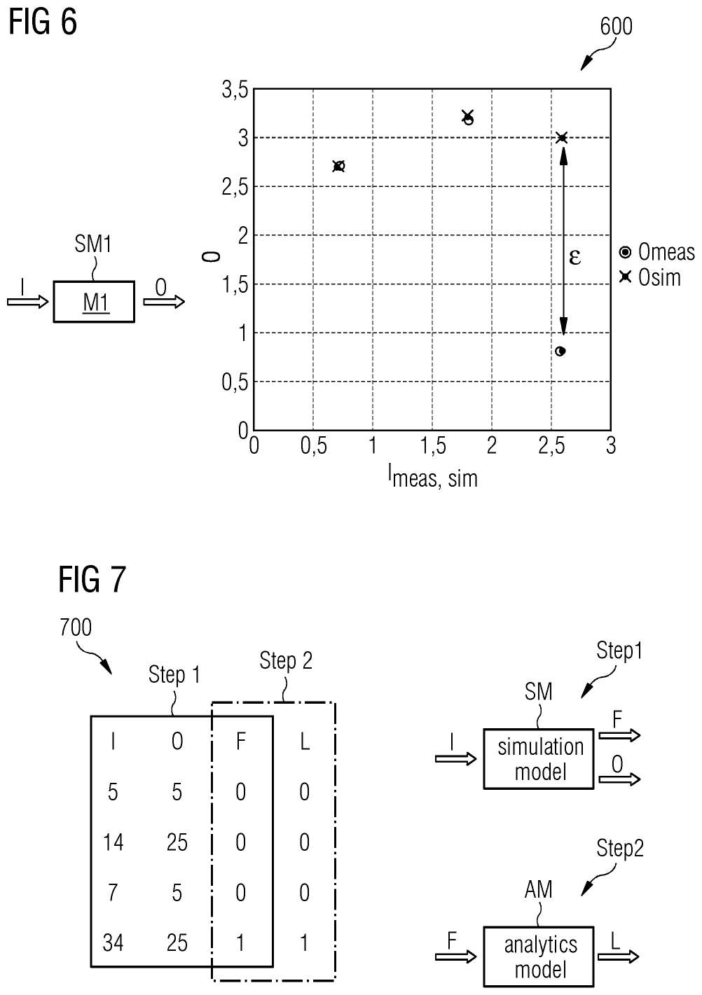

A computer system as depicted schematically in FIG. 1 with input data acquisition I, O, V, data simulation software, analytics software, and a possible user Interface guiding a user through the following procedure to combine an analytical and simulation model SM0, SM1 are provided. How the correct simulation model is chosen depends on a calculated value ε0, 1 and is described in detail below and in FIG. 6.

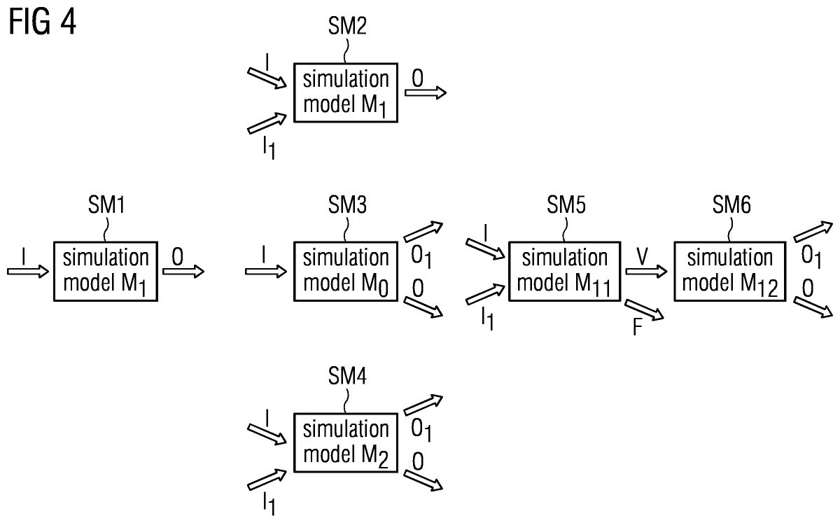

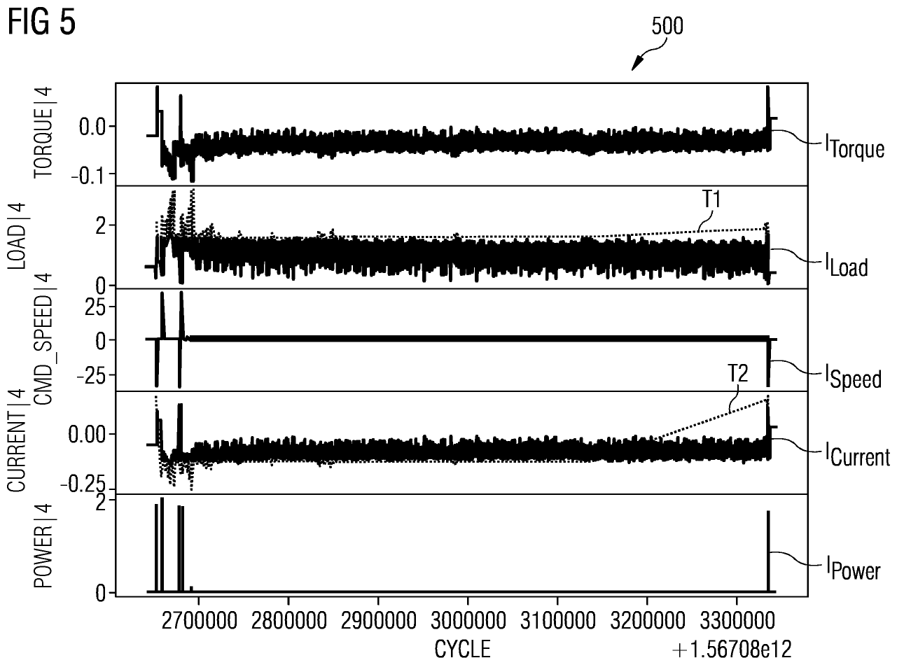

The simulation models and analytical models are combined on a semantic, syntactic, and lexical level. Different available simulation models for data analytics are represented in FIG. 4, with the Simulation Models SM1 to SM6 showing that it may be one or more different input data sources I, I1, V as one or more output data streams O, O1. It is even possible to combine more than one Simulation Model SM5, SM6, where an output of Simulation Model SM5 at least partly forms the input data for Simulation Model SM6.

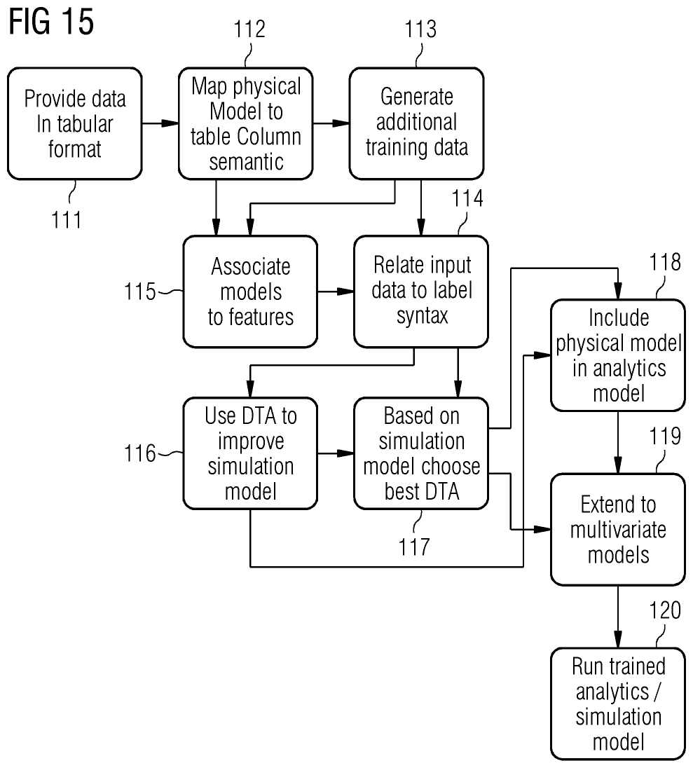

As a precondition for the procedure, physical factory, plant, machine, or device models that are used to set up factory, plant, or machine devices are built. Further, process data with labels from factories, plants, machines, or devices during operation has been acquired, and models have been parameterized to fit the acquired data for the labeled conditions. Then, the procedure is carried out to support data analysis with goals such as anomaly detection, root cause analysis, condition monitoring, prediction, or optimization based on acquired data and physical model. An overview of the analytics process for condition monitoring is shown in the diagram in FIG. 15.

In the case of anomaly detection, a simulation model SM0, SM1, SM2 is used to generate example anomaly data that is compared to the acquired data, or acquired data is input to the simulation model while comparing the output to other parts (e.g., other measurement channels or time frames) of the acquired data. A comparison is carried out by an error calculation or correlation. In case enough overlap of the simulated and acquired data is detected, a simulation model specific anomaly is notified.

In the case of root cause analysis, a simulation model is used to determine causes of anomalies by identifying signals that influence anomalies.

In the case of prediction, a simulation model is used to simulate future behavior and predict expected values.

In the case of optimization, parameters and input values of a simulation model are varied in order to find optimum output values.

In the case of condition monitoring, a simulation model is used to generate example data for a number of conditions, define feature information, explain which input data is relevant for which condition, and generalize and enhance analytics models.

A detailed description of the condition monitoring case contains the following acts a to j, depicted also as an overview in FIG. 15. Not all acts are mandatory to the method, and some acts may be skipped, depending on the purpose of the data evaluation.
a) For a classification analysis of normal operation and failure data for condition monitoring, the data may be presented in a tabular format 111 with measurement set in rows and feature information in columns, with the last column being the label normal operation (0) or different failure conditions (1,2,3, . . . ). Physical models have one or a number of inputs, outputs, and intermediate values that may be feature information or labels.

An example of such a table looks like that:

| I | O | F | L |
|---|---|---|---|
| 5 | 5 | 0 | 0 |
| 14 | 25 | 0 | 0 |
| 7 | 5 | 1 | 1 |
| 34 | 25 | 1 | 1 |
| 4 | 4 | 4 | 2 |

The values of the table may be used for simulation Models M, as different possibilities are shown in FIG. 4.
I, I1 measured and simulated data input
O, O1 measured and simulated data output
F measured and/or simulated feature information
V intermediate simulated data
L classification label
SM1, . . . , SM6 model for label L
b) The physical model is aligned to the acquired data 112 on a semantic level by mapping model inputs, outputs, and intermediate values to columns of the acquired data.

This process is automated and may be supported by a user interface (not shown in the figures) guiding the user through the analytics procedure.

The user interface may be used to map simulated to measured data automatically considering model labels (e.g., 1) and valid model regions. In one embodiment, mapping is carried out by scripts or standardized interfaces (e.g., Predictive Model Markup Language (PMML)—Functional Mock Up (FMU) mapper). The mapping is supported by similarity propositions.

The goal is to derive a decision tree that shows how the labeling classes depend on the acquired data so that based on acquired data, the existing condition class is automatically shown so that appropriate actions may be carried out by the maintenance staff or operator. In the automated case, the mapping procedure uses similarity scores that, in the user supported case, may also be proposed to the user.

Similarity scores are derived by finding word similarities of the input and output data descriptions and signal similarities by calculating signal correlations.

Similarity indicators to support the mapping between simulation and measured data for analytics are based on:

Word similarities:

Simulation model inputs and outputs are described in XML files such as FMU. For example,

<Type name=“Modelica.SIunits.AngularVelocity”>
<RealType quantity=“AngularVelocity” unit=“rad/s”/>
</Type>

Analytic model inputs and outputs are described in XML files such as PMML, ONNX. For example,

```
    <xs:simpleType name=″REAL-NUMBER″>
    <xs:restriction base=″xs:double″>
    </xs:restriction>
  </xs:simpleType>
<DataDictionary>
  <DataField name=″Y1″ optype=″continuous″ dataType=″double″/>
  <DataField name=“AngularVelocity″ op type=″continuous″
  dataType=″double″/>
  <DataField name=″date″ optype=″continuous“
  dataType=″dateDaysSince[1970]″ displayName=″TS-
VALUE″/>
  <DataField name=″z″ optype=″continuous″
  dataType=″double″ display
  Name=″ExternalRegressor″/>
</DataDictionary>
```

The method parses the XML description files and looks for similarities in hypertext and text descriptions. Similarity is defined comparing words and using semantic word nets, for example. Type name and simpleType name have a similarity score of 18/24=0.75; AngularVelocity and AngularVelocity have a similarity score of 1

Signal correlations: A cross correlation score between signals is considered to describe similarity. Additionally, anomalies are detected in signals, and two signals are considered similar if anomalies are recognized at similar time steps.

In the example shown in FIG. 5, a number of measures are taken in the manufacturing system, regarding power I_{power}, speed I_{speed}, current I_{current}, Load I_{load}, and torque I_{Torque}. As shown in the curves of I_{Load} and I_{Current}, thresholds T1 and T2 are exceeded at the same time cycles 3200000.

Multiple similarity scores may be aggregated, for example, by calculating a mean similarity score for the input and output variables.

Based on parsing the description of input and output values in standardized XML files from, for example, Functional Mock Up (FMU) for simulation models or Predictive Model Markup Language (PMML) for analytics models similarity scores (e.g., known from text analysis or using semantic webs are calculated). Cross-correlations between signals are calculated as an indicator for signal similarity. Also, the relative amount of common time steps with anomalies is taken as a similarity score. The scores for each simulation input/output measured analytics input/output data pair are aggregated (e.g., by calculating a mean score). Optionally, the mean score may also be visualized to the user in the User interface together with more detailed information of the aggregation procedure.
c) If the physical simulation models have been built to correspond to relevant conditions to be monitored, the physical simulation models are used to generate additional training data within the known valid regions, 113.

Proceeding with the forgoing example table, valid region: I>10; O>20

| Simulation Model | I | O | F | L |
|---|---|---|---|---|
| | 5 | 5 | 0 | 0 |
| | 14 | 25 | 0 | 0 |
| | 7 | 5 | 1 | 0 |
| | 34 | 25 | 1 | 1 |
| M0 | 12 | 24 | 0 | 0 |
| M0 | 11 | 23 | 0 | 0 |
| M0 | 13 | 25 | 0 | 0 |
| M0 | 15 | 25 | 0 | 0 |
| M0 | 16 | 25.5 | 0 | 0 |
| M0 | 18 | 26 | 0 | 0 |
| M0 | 20 | 26.5 | 0 | 0 |
| M1 | 22 | 28 | 1 | 1 |
| M1 | 24 | 26 | 1 | 1 |
| M1 | 30 | 24 | 1 | 1 |

then classification methods such as decision tree analysis DTA are used to learn an analytics model. First, relevant values and valid regions of a simulation model are identified. A valid model range is determined by simulating model outputs with interpolated and extrapolated input values and models associated with a given label, 115.

The input/output/label relation is checked whether it is consistent with the analytics model—if not, then a limit of the valid model range is reached.

Contradictions are tested for using a distance measure between simulations and measurements. For example,

ε=Σ_{i,j}|Iᵢⱼ^{meas}−Iᵢⱼ^{sim}|+Σᵢⱼ|Oᵢⱼ^{meas}−Oᵢⱼ^{sim}|

The measurement is used if there is a contradiction.

This is shown in an example in FIG. 6, where the maximum distance ε between the measured value Omeas and the simulated value Osim is at an Input value I of 2.5. The used Simulation Model SM1 is, for example, a simple one with only one Input Value I and one Output Value O.

Second, the amount of necessary simulation data is determined depending on the analytics method 114.

In the case of neural network analytics, the required amount of data increases with the number of neurons.

In the case of a decision tree analysis, the required amount of data increases with the minimum splitting value and depth of the tree.

Also, in the case of difficult conditions for analytics models such as unbalanced labels or too few data for the degrees of freedom of the analytics model, simulation models are used to increase the amount of available data. Further, for failure cases where a realization is cumbersome or even impossible, simulation models are used to fill this lack of data.

FIG. 7 shows a way to determine the best fit between a simulation model SM and a feature information, 115.

In act 1, the feature information F that may be represented and explained by simulation model SM will be defined (see table 700) based on Input data I and Output data O.

In act 2, the pre-trained feature information F that fits to label L and correlates to analytics model AM is defined.
d) In the feature engineering act 117, best DTA with best feature inputs for learning of analytics simulation models provide additional feature information. This feature information is used to build an analytics model so that certain feature information values are associated with certain labels. Simulation models may contain a number of intermediate values that are considered as potential feature information for feature engineering.

The feature information that may be represented and explained by the physical model are calculated from the measured data and used to build an analytics classification model so that labels are associated with feature information values.

In a second act, model feature information outputs for certain labels are compared to measured feature information at a given input. The simulation model yielding best agreement based on the feature information values (e.g., smallest error ε between model feature information and measured feature outputs) is associated with the respective label.

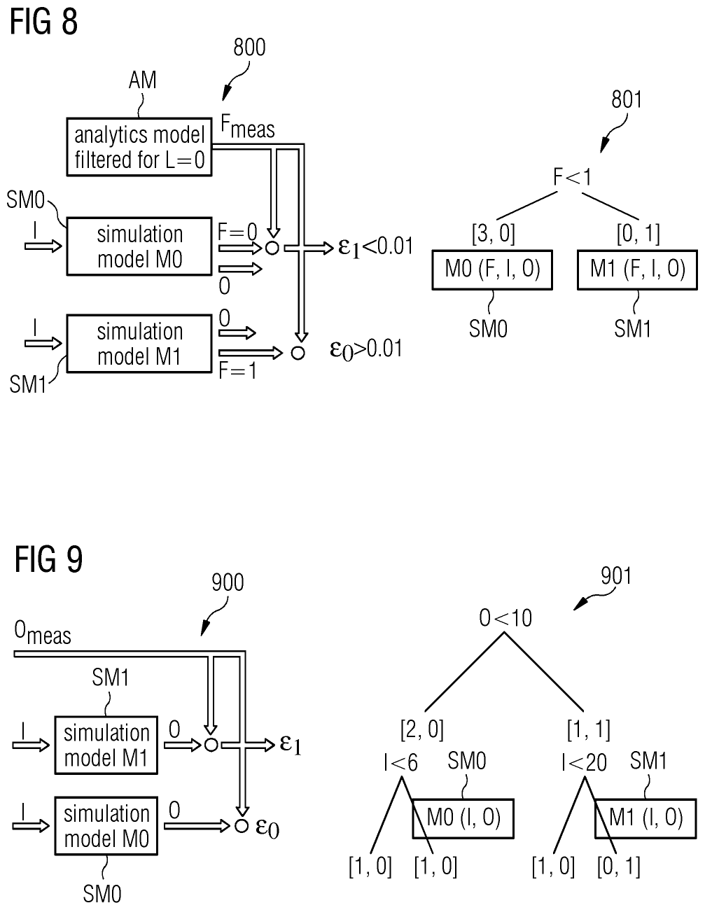

FIG. 8 shows the example of a decision tree analysis DTA where the feature information F derived from the simulation models is used to distinguish between different labels, each described by another model M0, SM0 or M1, SM1.

Act 1: Define a feature information that may be represented and explained by model.

Act 2: Define pre-trained feature information that fits to label and correlates to model.

Error ε=F₁ₘₑₐₛ−F₁ₛᵢₘ determines which simulation model describes the label with the respective feature information value.

[N0, N1] where N0 is the number of data sets with label

N1 number of data sets with label 1

In FIG. 8, for example, the small tree 801 shows [3, 0] on the left branch of the example tree and [0, 1] on the right branch. The data is still corresponding with the numbers of the table depicted in FIG. 7, 700. The Analytics Model AM is filtered for the Label L=0, so that in that case, for example, only feature data with label L=0 is used to train the analytics model. The value of feature information F decides whether the left branch of the decision tree is chosen with simulation model M0 or the right branch with simulation model M1.

In other words, a simulation model is used to provide relevant feature information that is related to simulation parameters (e.g., spring stiffness, speed, weight, torque, temperature, load, current, power), and thus to physical values and technical components of the manufacturing system, machine, or factory.
e) In the cases where no additional feature information is available, the simulation models are directly associated with labels as illustrated in FIG. 9. The numbers of the table are still similar to those in FIG. 7, 700, but without the column for the feature information F.

The processing of the data is depicted in the diagram 900, similar to that of 800, but without the Analytics Model AM, filtered for Label L=0. In this example, for each label, the measured output O values are compared to the output of each simulation model SM0, SM1 at the same input I. The simulation model with the smallest error is then associated with the label.

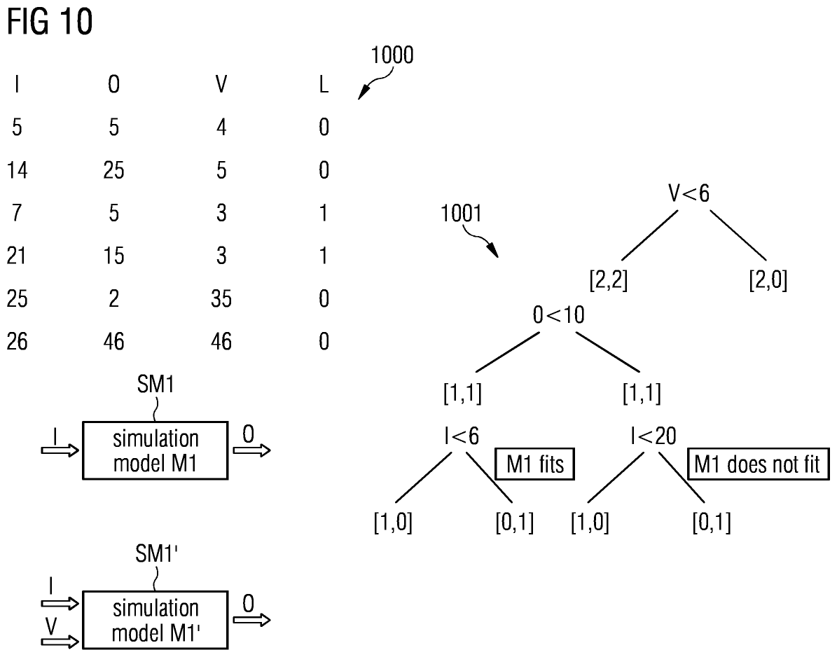

In a decision tree analysis, the models are hence already implicitly associated to branches of the tree 901 on a syntax level.
f) In case of contradictions between the analytics and the simulation model, measured values from the decision tree analysis are used to improve the simulation model, 116. In a first act, relevant feature information from a decision tree analysis is identified. If the simulation model does not contain all feature information that is used in a decision tree analysis to classify the data sets, the simulation model is modified from SM1 to SM1′ to include these feature information values V; this is depicted in the example and table 1000 in FIG. 10.

In the decision tree 1001, it is noted that on the left side with V<6, O<10, and I<6, the Simulation Model M1 fits, but on the other side, with V<6, O>=10, and I>=20, M1 does not fit.

Feature information values are added as inputs if the feature information values are less correlated to the existing inputs but more correlated to outputs, and are added as outputs if the feature information values are less correlated to the existing outputs but more correlated to inputs.

In a second act, simulation model parameters are adapted to reproduce all feature information that is used by the analytics. In a fault classification example with time series input that is preprocessed by a Fourier transformation into frequency space, the analytic decision tree analytics model has shown the frequency feature columns of importance (e.g., 0 and 20) that may be used to classify the data into label 0 (good) and label 1 (faulty) conditions.

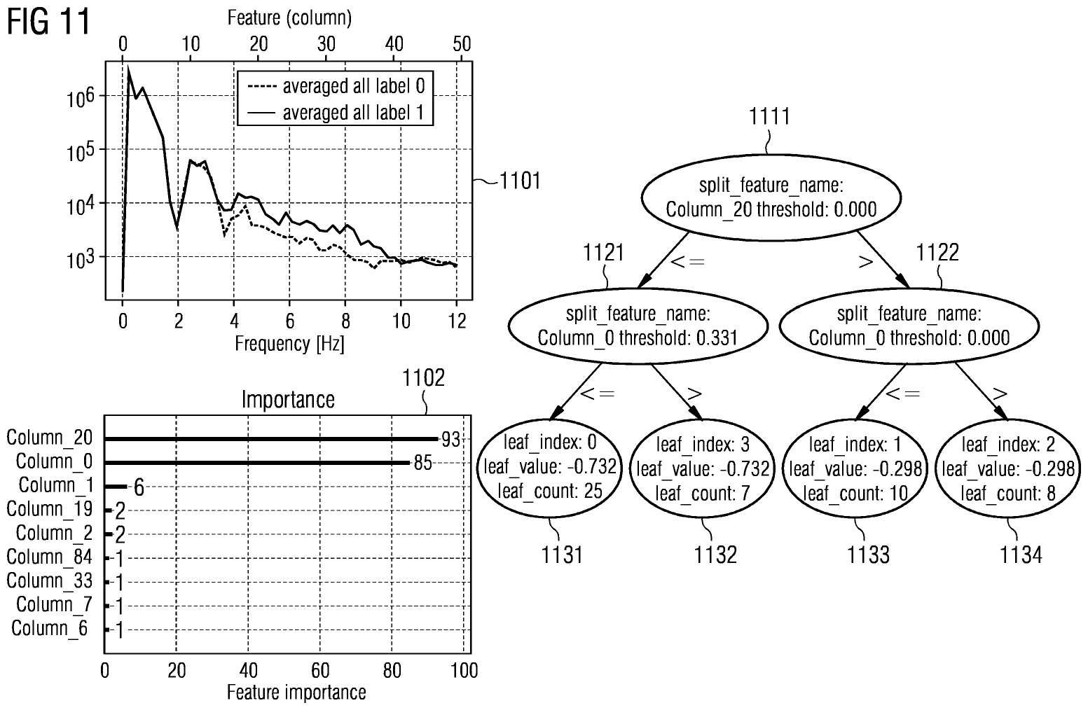

Hence, the simulation model used to generate more data was designed to contain a resonance frequency of 4.5 Hz corresponding to feature column 20, as shown in FIG. 11.

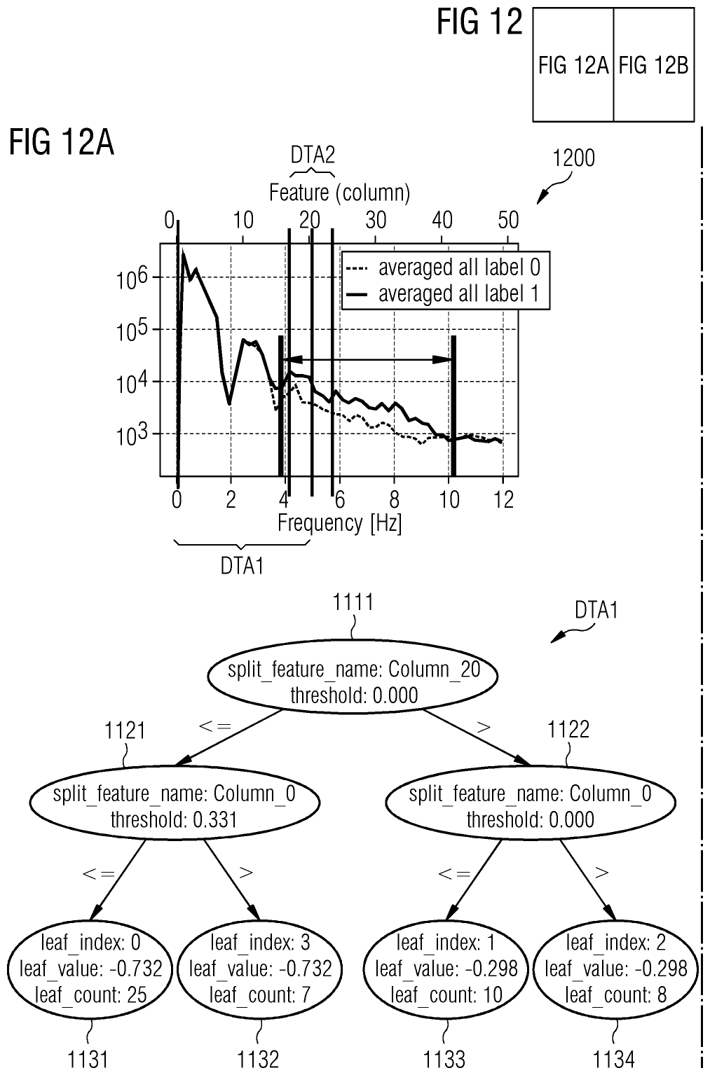

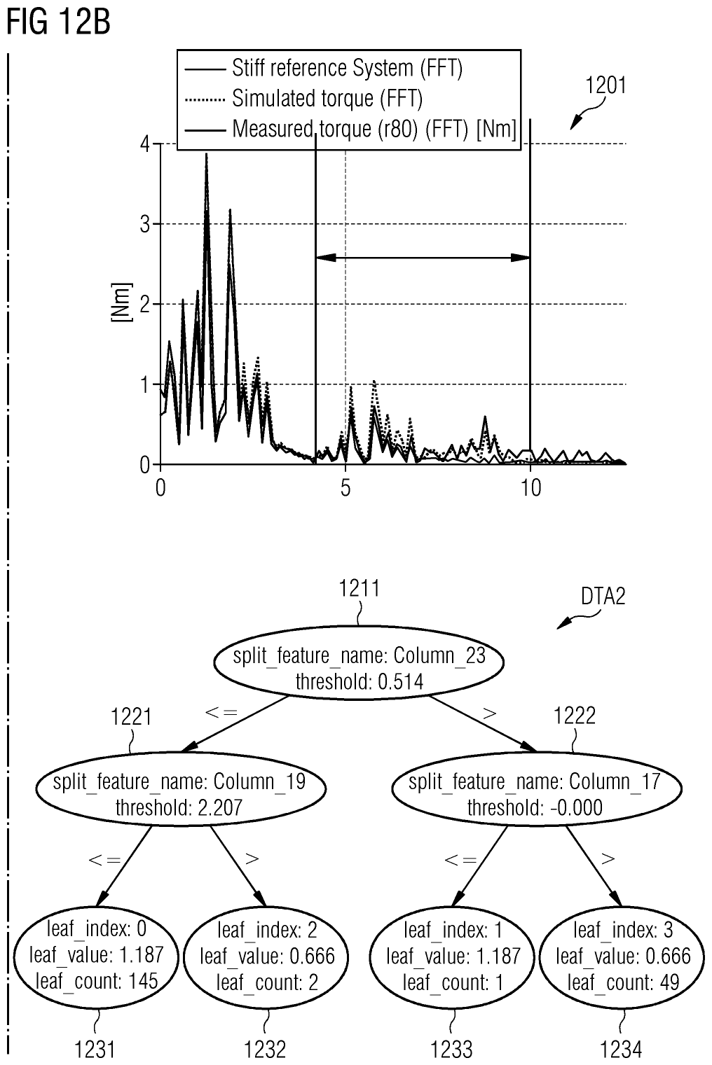

The simulations module is improved to contain a resonance frequency at 4.5 Hz corresponding to feature information 20 that is used by the decision tree to distinguish classes with label 0 and 1.
g) In case a number of analytics models are given as a training result, a simulation helps to choose the right analytics model, 117 (e.g., when a simulation model indicates that a classification is only valid in a certain range of input and output values 1101, a decision tree may be reduced to this validation range as shown in FIG. 12). The simulation model is improved to contain a resonance frequency at 4.5 Hz, corresponding to feature information value 20 that is used by the decision tree to distinguish classes with label 0 and 1.

In an application example, an analysis leads to two decision trees that both give 100% accuracy. A simulation model, however, indicates that only feature information values 17 to 40 would give robust, physically explainable classification, so that the decision tree model building on feature information values in this range is chosen.

In that way, the simulation results also help to choose the decision tree model, such that the complexity and/or the depth of the tree, which is the main source of overfitting, is reduced.
h) In order to improve the classification accuracy and to avoid overfitting, physical models may be included in the analytics model in an embodiment, 118. In the case of a decision tree analysis, branches that are formed by inputs and outputs of the physical models are placed with physical models associated with labels that are the classification groups of the decision tree. As shown in FIGS. 12A and 12B, this replacement reduces the uncertainty of setting thresholds that define the tree branches by using exact physical model relations with known uncertainty boundaries and validation regions.

The diagram in FIG. 12A shows the feature value (e.g., current amplitude for each feature, such as Frequency in Hz for labels 0 and 1). The decision trees DTA1 and DTA2 shown below were trained on feature data using both labels. The visualization of the decision trees indicates that DTA1 bases its classification decision for label 0 and 1 on columns 0 and 20, whereas DTA2 bases the classification decision on feature columns 17, 19 and 23. A simulation model may now support to choose a suitable DTA.

The diagram in FIG. 12B, 1201, shows a simulated torque spectrum for optimized simulation parameters, compared to the measured spectrum, and simulated spectrum of a stiff reference system as an example.

Simulations indicate that features between 17 and 40 (e.g., corresponding to frequency ranges 4.5 to 10 Hz) are best indicators for separation, so that DTA 2 may be chosen.

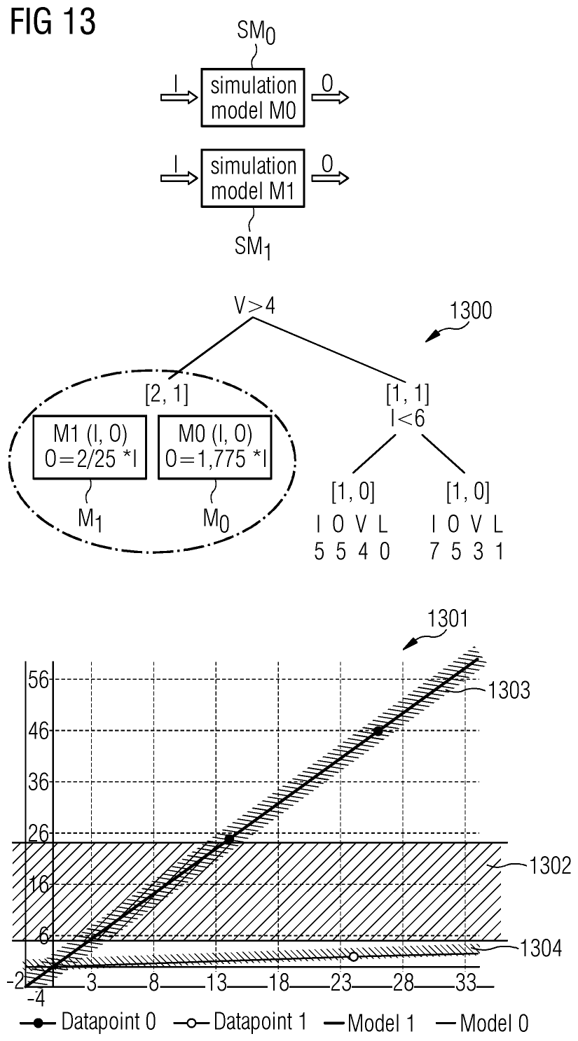

Another example is shown in FIG. 13. In the traditional decision tree analysis when there are too few data points, there is a large freedom, 1302, to choose branching criterions. Simulation models reduce the freedom when added to the tree by introducing boundaries on the validity regions, 1303, so that classification precision is improved. The decision tree 1300 with the corresponding simulation models M0 and M1 is depicted also in FIG. 13.

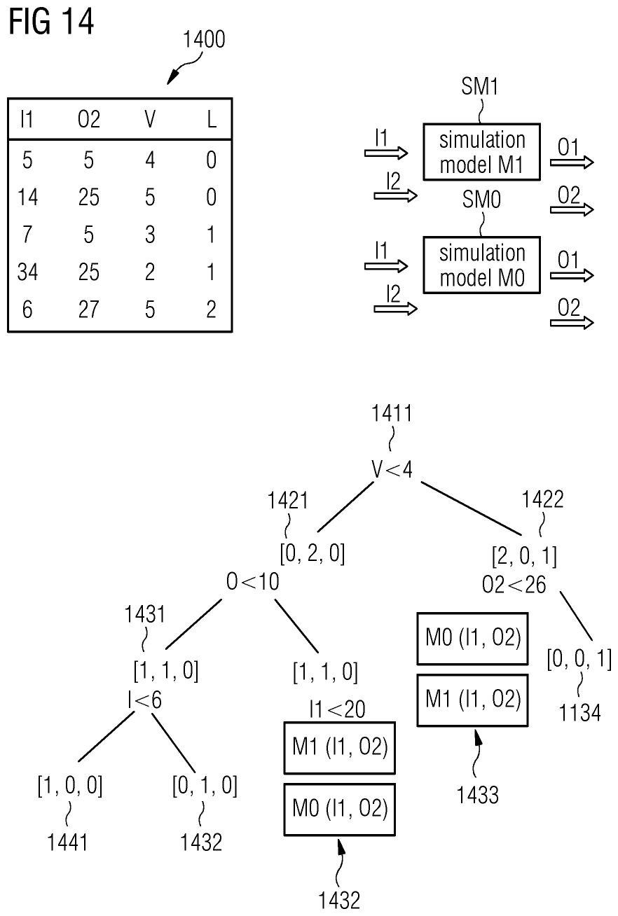

An example pseudocode implementation for the example depicted in FIG. 14 is shown below:

```
The Traditional decision tree:
Read I, O, V
If V > 4
  if I < 6
    L=0
  else
    L=0
else
  if O < 24
    L=1
  else
    L=0
Output L
Simulation-augmented decision tree:
Read I, O, V
If V > 4
  if I < 6
    L=0
  else
    L=0
else
  Osim0=2/25*I
  err0=abs(Osim0−O)
  Osim1=1,77*I
  err1=abs(Osim1−O)
  if err0>err1
    L=1
  else
    L=0
Output L
```

That example of an augmented decision tree 1411 with Simulation Models M0, M1 and data table 1400 shows the combination of simulation and analytics model on the lexical level.

The method of the present embodiments shows the following advantages: Instead of using additional simulated data, simulation models are directly introduced in the decision tree. By including simulation models in branches of decision trees, the decision tree depth is reduced, and accuracy is enhanced at a given number of data sets.

As a result, overfitting is reduced because a simulation model describes a physical behavior that is more generally valid.

For each class, a separate model may be used. An additional class is introduced, which indicates the points that cannot be labeled correctly.
i) The single input-output simulation model case is extended to multivariate ML models, 119, by successively replacing all branches that contain inputs and outputs of the simulation models for the classification labels, so that the simulation model may be used at a number of tree branches, as shown in FIG. 14, provided that the contradictions mentioned in act f) have been resolved by sufficient modifications of the simulation model.

j) Finally, the combined trained machine learning/simulation model is used for continuous classification as shown in FIG. 1, 120.

In comparison to the prior art solution, the procedure of the present embodiments has further advantages: The physical meaning of data inputs increases the acceptance of analytics model by humans in the sense of explainable AI.

A generalization of analytics model to physically relevant findings makes analytics also more explainable.

Additionally, the support of the feature engineering process is improved by proposing physically relevant feature information.

Further, the support of the simulation model creation process by analytics models and simulation data leads to analytics models that are more robust to changes in the environment, and the overfitting to a limited number of data sets is reduced. Generation of simulation data over a wide range of conditions, especially for the fault cases, increases the amount of training data and thus helps to overcome overfitting.

The support of analytics model selection by single and multivariate simulation models improves precision of classification areas and reduces tree complexity.

The method offers support to operate analytics and simulation models simultaneously.

The following technical feature information contribute to the mentioned advantages: an optional user interface to map simulation model inputs/outputs to data columns on a semantic level using similarity scores for user guidance; the management of labeled models, simulation data, and improvements to analytics models; use of a simulation model to propose relevant feature information that is related to simulation parameters (e.g., spring stiffness), and thus to physical values and technical components of the machine/factory; proposed improvements to simulation models, based on relevant feature information and identified by a decision tree analysis; relevant decision trees are based on simulation results so that the complexity/depth of the tree, which is the main source of overfitting, is reduced; inclusion of a simulation model in a decision tree on a lexical and syntax level so that robustness and precision are increased; and support of continuous operation of decision tree models with included simulation models.

The present embodiments provide a combination of system simulation models and decision trees (e.g., the integration, such as replacement of tree-branches with a simulation model). Also, a proposition to map simulation inputs/outputs to measurement and analytics data columns based on a similarity measure of description, anomaly similarity, and correlation is provided.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for an augmented decision tree analysis in a machine learning algorithm (MLA) for a manufacturing system, the method comprising:
inputting data containing data acquired during operation;
amending the input data with feature information; and
applying the input data in a decision tree analytics model with leaves, each of the leaves of the decision tree associated to a label giving information about an operational condition of the manufacturing system and branches of the decision tree that represent conjunctions of feature information that lead to a labeled state,
wherein there is at least one simulation model that shows dependencies between the label and the input data, and
wherein one or more simulation models of the at least one simulation model replace at least one part of at least one of the branches of the decision tree.

2. The method of claim 1, wherein the decision tree is a Gradient Boosted Decision Tree.

3. The method of claim 1, wherein the data is presented in a tabular form, with measurement sets in rows and correlated feature information, label, or a combination thereof in column.

4. The method of claim 1, further comprising, in a feature engineering step, building the decision tree analytics model, the building of the decision tree analytics model comprising:
associating certain feature information values with certain labels;
comparing a feature information output for label to measured feature information values at a given input; and
associating best agreement based on the feature information values by smallest error between model feature value and measured feature outputs with the respective label by a Feature Selector.

5. The method of claim 1, further comprising detecting an anomaly, the detecting of the anomaly comprising:
generating, using a simulation model, example anomaly data that is compared to process data that has been collected during operation; or
inputting collected process data to the simulation model while comparing an output to other measurement channels or time frames of the collected process data.

6. The method of claim 5, wherein the comparing is carried out by an error calculation or correlation, and
wherein when more than 50% overlap of the simulated data and the collected data is detected, a simulation model specific anomaly is notified smallest error between model feature information and measured feature outputs.

7. The method of claim 1, further comprising determining cause of anomalies using the at least one simulation model, the determining of the cause of anomalies comprising identifying signals that influence anomalies by a cause analysis.

8. The method claim 1, wherein the at least one simulation model is used to simulate future behavior and predict expected values.

9. The method of claim 1, further comprising varying simulation model parameters of at least one simulation model, such that an error function defined through simulated and measured output values is minimized.

10. The method of claim 1, further comprising generating, using the at least one simulation model example data for at least one condition, with defined feature information, correlate;
correlating, using the at least one simulation model, the input data to the at least one condition; and
generalizing and enhancing, using the at least one simulation model, the decision tree analytics model.

11. (canceled)

12. A system for an augmented decision tree analysis in a machine learning algorithm (MLA) for a manufacturing system, the system comprising:
a feature generator configured to amend input data with feature information;
a feature selector;
the MLA configured to implement a decision tree analytics model with each leaf of a decision tree being associated with a label giving information about an operational condition of the manufacturing system and branches of the decision tree representing conjunctions of feature information that lead to the label;
at least one simulation engine showing dependencies between the label and the input data,
wherein one or more simulation models of the at least one simulation model replace at least one part of at least one of the branches of the decision tree.

13. The system of claim 12, wherein the decision tree is a Gradient Boosted Decision Tree.

14. The system of claim 12, wherein the input data used is presented in a tabular form, with measurement sets in rows and correlated feature information, label, or a combination thereof in column.

15. The system of claim 12, wherein the system is configured for an anomaly detection, the anomaly detection comprising:
generation of example anomaly data by a simulation model that is compared to process data that has been collected during operation; or
input of collected process data to the simulation model while comparing the output to other measurement channels or time frames of the collected process data.

16. The system of claim 15, wherein an error calculator carries out the comparison, and
wherein when more than 50% overlap of the simulated data and the collected data is detected, a simulation model specific anomaly is notified indicating a smallest error between model feature information and measured feature outputs.

17. The system of claim 12, wherein the at least one simulation engine is configured to determine cause of anomalies, the determination of the cause of anomalies comprising identification of signals that influence anomalies by a cause analysis.

18. The system of claim 12, wherein the at least one simulation engine is configured to simulate future behavior and predict expected values.

19. The system of claim 12, wherein model parameters of the at least one simulation model are varied, such that an error function defined through simulated and measured output values is minimized.

20. In a non-transitory computer-readable storage medium that stores instructions executable by one or more processors for an augmented decision tree analysis in a machine learning algorithm (MLA) for a manufacturing system, the instructions comprising:
inputting data containing data acquired during operation;
amending the input data with feature information; and
applying the input data in a decision tree analytics model with leaves, each of the leaves of the decision tree associated to a label giving information about an operational condition of the manufacturing system and branches of the decision tree that represent conjunctions of feature information that lead to a labeled state,
wherein there is at least one simulation model that shows dependencies between the label and the input data, and
wherein one or more simulation models of the at least one simulation model replace at least one part of at least one of the branches of the decision tree.
